(19) United States
(12) Patent Application Publication
(10) Pub. No.: US 2026/0141910 A1
(43) Pub. Date: May 21, 2026

(54) Selective Background Noise Suppression

(71) Applicant: Zebra Technologies Corporation, Lincolnshire, IL (US)

(72) Inventors: Fredrik Stenmark, Gothenburg (SE); Nicholas John James, Mississauga (CA); Shiva Prakash, Ronkonkoma, NY (US)

(21) Appl. No.: 18/949,512

(22) Filed: Nov. 15, 2024

(51) Int. Cl. G10L 21/0208

(52) U.S. Cl. CPC G10L 21/0208

(57) ABSTRACT

A method includes: establishing a communication session between a first communication device and a second communication device; processing a command from the first communication device to control background noise suppression of the second communication device; and controlling the background noise suppression based on the command.

### BACKGROUND

A communication device, such as a smartphone, when used for a voice or video call, may capture the voice of the device's operator as well as other sounds, e.g., background noise from the device's surroundings. The device may process captured audio before sending the processed audio to another party to the call. However, such processing may result in the loss of information.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a communication system.

FIG. 2 is a flowchart of a method of selective background noise suppression in the system of FIG. 1.

FIG. 3 is a diagram illustrating an example performance of the method of FIG. 2.

FIG. 4 is a flowchart of a method of selective background noise suppression control in the system of FIG. 1.

FIG. 5 is a diagram illustrating an example performance of the method of FIG. 4.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Examples disclosed herein are directed to a method including: establishing a communication session between a first communication device and a second communication device; processing a command from the first communication device to control background noise suppression of the second communication device; and controlling the background noise suppression based on the command.

Additional examples disclosed herein are directed to a communication device including: a communication interface; and a processor configured to: establish a communication session with a second communication device; receive a command from the second communication device to control background noise suppression; and control the background noise suppression based on the command.

Further examples disclosed herein are directed to a communication device including: a communication interface; and a processor configured to: establish a communication session with a second communication device; generate a command to control background noise suppression at a second communication device; and send the command to the second communication device.

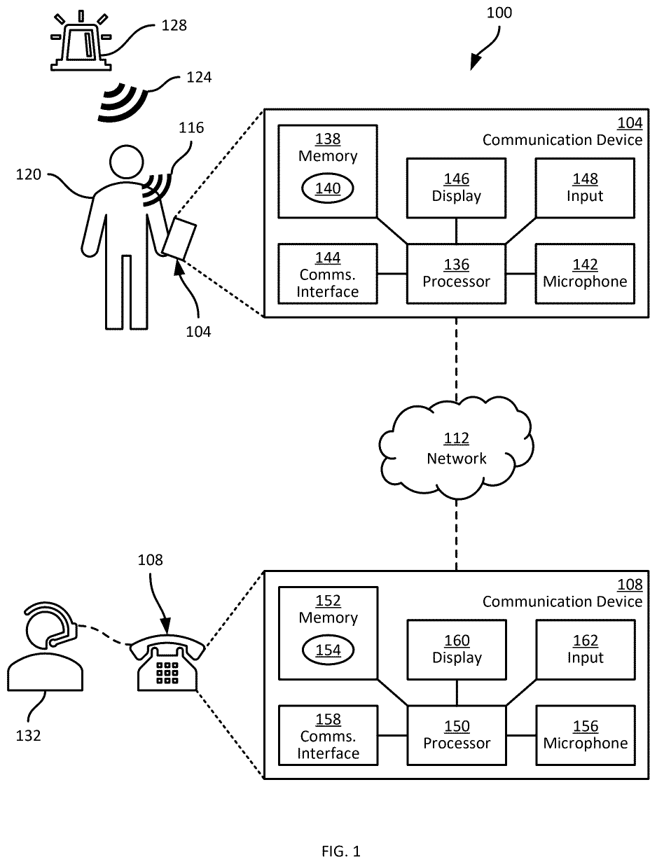

FIG. 1 illustrates a communication system 100 configured to provide call functionality to communication devices, such as a first communication device 104 (also referred to herein as the device 104), and a second communication device 108 (also referred to herein as the device 108). In the illustrated example, the device 104 includes a mobile device such as a smartphone, and the device 108 includes a desktop telephone set. In other examples, however, the device 104 and/or the device 108 can be implemented in any of a wide variety of form factors. For example, either or both of the device 104 and device 108 can be implemented as mobile devices (e.g., smartphones, wearable computers, tablet computers, or the like), or as desktop devices (e.g., telephone sets, desktop computers, or the like). Either of the device 104 and the device 108 can initiate a call, such as a voice call or a video call, with the other device via a network 112. In other examples, such calls can involve more than two devices, although the discussion below provides two devices for illustrative purposes.

The network 112 can include any suitable combination of wired and/or wireless networks, including local-area networks such as wireless local area networks based on the Institute of Electrical and Electronics Engineers (IEEE) 802.11 family of communication standards, and/or wide-area networks such as cellular telecommunications networks based on any suitable standard(s) maintained by the Third Generation Partnership Project (3GPP).

When a call is established between the device 104 and the device 108, according to the network(s) facilitating communications between the devices 104 and 108, the device 104 can capture audio data representing one or both of foreground audio 116 corresponding to the speech of an operator 120 of the device 104, and background audio 124 corresponding to any of a variety of other sounds (e.g., distinct from the voice of the operator 120) in the physical environment of the device 104, such as sound generated by a siren 128. As will be apparent, the background audio 124 can include various other sounds, including traffic, speech from people other than the operator 120, and natural sounds (e.g., wind, flowing water, or the like).

The audio data captured by the device 104 can be sent to the device 108 via the network 112, and rendered via a suitable transducer at the device 108, e.g., in a form audible to an operator 132 of the device 108. As will be understood by those skilled in the art, the device 108 can also capture audio (e.g., including speech from the operator 132) and transmit such captured audio to the device 104 via the network 112. It will further be understood that audio data sent from either of the devices 104 and 108 is not necessarily sent directly to the other of the devices 104 and 108. Transmitted audio data can ultimately arrive at the other of the devices 104 and 108 via one or more elements of the network 112, including base stations, switching centers and/or other routing devices, core network devices, and the like.

The background audio 124 may interfere with the foreground audio 116. For example, the nature and/or volume of the background audio 124 may render the foreground audio 116 difficult to understand for the operator 132. The device 104 may therefore implement functionality to suppress the background audio 124 before sending captured audio during a call. The audio data sent to the device 108 may therefore include the foreground audio 116 (or at least a portion thereof), and little or none of the background audio 124. Various mechanisms will occur to those skilled in the art for filtering or otherwise suppressing the background audio 124 from audio data sent to the device 108. For example, the device 104 can capture audio via two or more microphones and compare captured audio from each microphone to distinguish between the foreground audio 116 and other sounds. In other examples, the device 104 can execute a classifier (e.g., implementing a neural network) that takes the captured audio (whether from one microphone or more than one) as input and generates as output segments corresponding to the foreground audio 116 and the background audio 124. Having segmented the foreground audio 116 and the background audio 124, the device 104 can reduce the amplitude of the background audio 124, discard the background audio 124, or the like.

Under some conditions, however, suppression of the background audio 124 may result in information loss to the operator 132. For example, the device 108 may be a component of a Public Safety Answering Point (PSAP) configured to receive emergency calls from devices such as the device 104. The device 108 may therefore also be referred to as a public safety communication device. During an emergency call, the background audio 124 may provide contextual information associated with one or more of the geographic location of the operator 120, the physical environment the operator 120 is in, and the like. The transmission of background noise from the physical environment of the device 104 to the device 108 may also be advantageous in various other contexts beyond emergency calls.

The device 104 is therefore configured, as discussed below, to selectively suppress the background audio 124 from the audio stream sent to the device 108 during the above-mentioned call. As will be understood by those skilled in the art, the device 108 can also implement the functionality described herein in conjunction with its implementation by the device 104, such that either or both endpoints in a call can selectively suppress background noise from transmission to the other endpoint, or include the background noise in transmissions to the other endpoint.

Certain internal components of the device 104 and the device 108 are illustrated in FIG. 1. The device 104 includes a processor 136, such as a central processing unit (CPU), graphics processing unit (GPU), application-specific integrated circuit (ASIC), or the like. The processor 136 is communicatively coupled with a non-transitory computer-readable storage medium such as a memory 138, e.g., a combination of volatile memory elements (e.g., random access memory (RAM)) and non-volatile memory elements (e.g., flash memory or the like). The memory 138 stores a plurality of computer-readable instructions in the form of applications, including in the illustrated example an audio processing application 140, whose execution by the processor 136 configures the device 104 to process captured audio to selectively enable or disable suppression of background audio 124. Execution of the application 140 can also configure the device 104 to send and receive audio data to and from the device 108 during a call. In other examples, the functionality implemented by the application 140 can be implemented in hardware via an ASIC, field-programmable gate array (FPGA), or the like.

The device 104 further includes one or more microphones 142, e.g., disposed at various locations on a housing of the device 104, to capture the above-mentioned audio data. The microphone(s) 142 can provide the captured audio to the processor 136 for processing via execution of the application 140, and for subsequent transmission to the device 108.

The device 104 can also include a communications interface 144, enabling the device 104 to communicate with other devices, such as the device 108, via any suitable communications links, including those forming and/or implemented by the network 112. The interface 144 can include, for example, one or more antennas, radio transceivers, baseband controllers, and the like.

The device 104 can also include a display 146, and an input device 148 (e.g., a touch screen integrated with the display 146, a keypad, or the like). In some examples, the display 146 can be omitted, e.g., if the device 104 is implemented as a telephone set. The device 104 can also include other output devices in some examples, including a speaker to reproduce audio received from the device 108.

The device 108 includes a processor 150, such as a central processing unit (CPU), graphics processing unit (GPU), application-specific integrated circuit (ASIC), or the like. The processor 150 is communicatively coupled with a non-transitory computer-readable storage medium such as a memory 152, e.g., a combination of volatile memory elements (e.g., random access memory (RAM)) and non-volatile memory elements (e.g., flash memory or the like). The memory 152 stores a plurality of computer-readable instructions in the form of applications, including in the illustrated example a call control application 154, whose execution by the processor 150 configures the device 108 to send and receive audio during calls (e.g., with the device 104). In some examples, execution of the application 154 by the device 108 configures the device 108 to send one or more commands to the device 104 to alter background noise suppression functionality at the device 104 (e.g., commands to enable or disable background noise suppression by the device 104). In other examples, the functionality implemented by the application 154 can be implemented in hardware via an ASIC, field-programmable gate array (FPGA), or the like.

The device 108 further includes one or more microphones 156 to capture audio data representing either or both of speech from the operator 132, and background noise. The microphone(s) 156 can provide the captured audio to the processor 150 for processing via execution of the application 154, and for subsequent transmission to the device 104.

The device 108 can also include a communications interface 158, enabling the device 108 to communicate with other devices, such as the device 104, via any suitable communications links, including those forming and/or implemented by the network 112. The interface 158 can include, for example, one or more antennas, radio transceivers, baseband controllers, and the like. The device 108 can also include a display 160, and an input device 162. In some examples, the display 160 can be omitted, e.g., if the device 108 is implemented as a telephone set. The device 104 can also include other outputs in some examples, including a speaker to reproduce audio received from the device 104. In other examples, input and output functions can be implemented by a peripheral or client device, such as a headset, keypad, or the like, that is logically distinct from the device 108 and communicatively connected with the device 108. For example, where the device 108 is a component of a PSAP or other emergency call answering system, the device 108 can be implemented as a server or the like, configured to handle a plurality of calls, and connected with a plurality of client devices corresponding to individual operators 132.

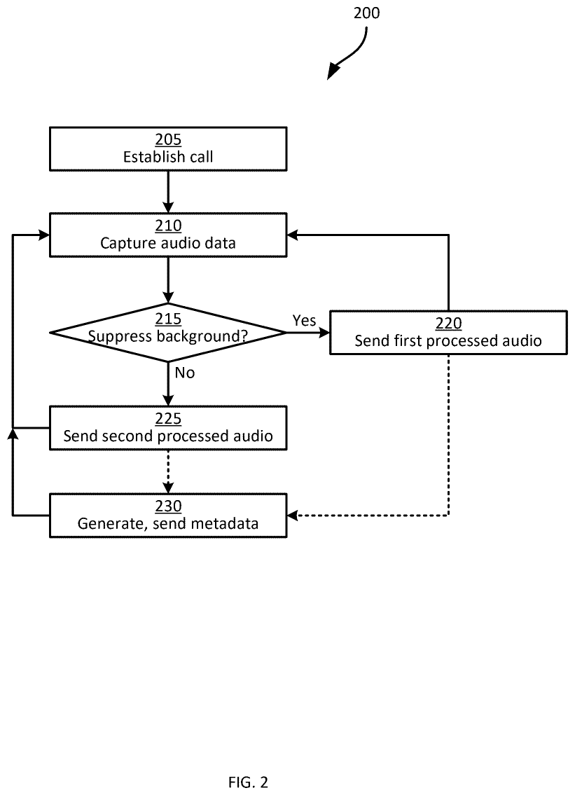

Turning to FIG. 2, a method 200 of selective background noise suppression is illustrated. The method 200 is described below in conjunction with its performance by the device 104, e.g., via execution of the application 140 by the processor 136, and/or by equivalent dedicated hardware elements such as an ASIC, field-programmable gate array (FPGA) or the like implementing the functionality of the application 140.

At block 205, the device 104 is configured to establish a call with the device 108. Establishment of a call can include one or more message exchanges with the device 108 and/or intermediate infrastructure associated with the network 112. For example, in the case of an emergency call, network infrastructure can be configured to route an outgoing call message (e.g., an Invite message formatted according to the Session Initiation Protocol (SIP) or other suitable protocol) from the device 104 to one of a plurality of PSAPs based on a location of the device 104. In the case of a non-emergency call, the network 112 can route an outgoing call message to the device 108 based on an identifier of the device 108 included in the outgoing call message. In some examples, call establishment at block 205 need not be initiated by the device 104. In such examples, the call can be initiated by the device 108, e.g., via transmission of an invite message with an identifier of the device 104, which can be routed to the device 104 via the network 112.

At block 210, following establishment of the call, the device 104 is configured to capture audio data via the microphone(s) 142. As noted above, the audio data captured at block 210 can include either or both of speech from the operator 120, also referred to as foreground audio 116 or a foreground component 116, and background audio 124, also referred to as a background component 124. The device 104 is also configured, at block 210, to segment the background audio 124 and the foreground audio 116 from the captured audio. As will be apparent, the captured audio can include an audio stream representing a combination of the foreground audio 116 and the background audio 124. The device 104 can be configured to extract, from the “raw” audio stream, foreground and background components using comparative mechanisms between distinct microphones, machine-learning based techniques, or the like.

At block 215, the device 104 is configured to determine whether to suppress the background audio 124. The determination at block 215 can take a variety of forms. In some examples, the determination at block 215 includes determining that a type of the call established at block 205 matches a target call type, e.g., stored in a configuration setting in the memory 138, as a portion of the application 140, or the like. For example, the target call type can be an emergency call (e.g., initiated by dialing “911” in North America and portions of Central and South America). The device 104 can thus determine, at block 215, whether the call established at block 205 was initiated by dialing 911 or another emergency number. In other examples, a message sequence used to set up an emergency call within the network 112 can include attributes indicating that the call is an emergency call, such as a PSAP identifier field in a SIP message provided to the device 104. In these examples, when the call type does not match the target call type, the device 104 can be configured to suppress the background audio 124 in the processed audio stream sent to the device 108. When the call type matches the target call type, the device 104 can be configured to modify or disable background suppression, as discussed below.

In other examples, at block 215 the device 104 can determine whether an amplitude or volume of the foreground audio 116 is above a threshold. For example, when the amplitude of the foreground audio 116 exceeds the threshold, indicating that the operator 120 is speaking, the device 104 can be configured to suppress the background audio 124. When the amplitude of the foreground audio 116 indicates that the operator 120 is not speaking, or if no foreground audio 116 is detected (e.g., an amplitude of zero for the foreground audio 116), the determination at block 215 can be negative, and the device 104 can disable or modify background suppression.

In further examples, the device 104 can make the determination at block 215 based on other attributes of the audio captured and segmented at block 210. For example, the device 104 can be configured to process the background audio 124 to detect certain types of sound, and enable or disable background suppression in the audio sent to the device 108 based on the presence or absence of such sounds. For example, the device 104 can be configured to process the background audio 124 to detect sound corresponding to a public address system or the like (e.g., which may be indicative of a location of the operator 120), and to disable background noise suppression in response to the detection.

The above criteria can be combined in some examples. That is, the determination at block 215 can be negative (resulting in disabling or modifying background noise suppression) when the call type matches the target call type and the operator 120 is not speaking, and affirmative otherwise.

Other criteria can also be employed by the device 104 at block 215, in addition to or instead of those mentioned above. In some examples, at block 215 the device 104 can determine whether a command has been received from the device 108 to disable or enable (or otherwise modify) background noise suppression. For example, when no such command has been received, the device 104 can be configured to suppress the background audio 124 by default (that is, the determination at block 215 can be affirmative by default).

Following the determination at block 215, the device 104 proceeds to either block 220, if the determination at block 215 is affirmative, or block 225, if the determination at block 215 is negative. When the determination at block 215 is affirmative (e.g., when the call type does not match the target call type, the operator 120 is speaking, no command has been received from the device 108, or the like), the device 104 is configured to send first processed audio data to the device 108 at block 220. The first processed audio data includes the foreground component 116 of the audio data remaining after suppression of the background component 124. In other words, to generate the first processed audio data, the device 104 is configured to reduce the amplitude of the background audio 124, up to and including discarding the background audio 124 (e.g., reducing background amplitude to zero). The remainder of the audio data from block 210, after such suppression, includes the foreground audio 116. The remainder can include a portion of the background audio 124, for example if suppressing the background audio 124 includes attenuating but not eliminating the background audio 124.

When the determination at block 215 is negative (e.g., when the call type matches the target call type, the operator 120 is not speaking, and/or a command has been received from the device 108), the device 104 is configured to send second processed audio to the device 108 at block 225. The second processed audio data includes at least the background audio 124, and may also include the foreground audio 116. In other words, to generate the second processed audio data, the device 104 does not suppress the background audio 124. The device 104 can, for example, maintain an amplitude of the background audio 124, or amplify the background audio 124, in the second processed audio data.

Various mechanisms are contemplated for sending the second processed audio to the device 108. In some examples, the device 104 can send the raw audio stream captured at block 210. In other examples, as noted above, the device 104 can amplify the background audio 124, combine the amplified background audio with the foreground audio 116, and send the resulting combination to the device 108. In further examples, sending the second processed audio can include sending the background audio 124 and the foreground audio 116 in separate streams. For example, the device 104 can be configured to multiplex the background audio 124 with the foreground audio 116 (e.g., using time-division multiplexing) and transmit the multiplexed audio data to the device 108. The device 108, in turn, can be configured to extract the foreground audio 116 and the background audio 124 from the multiplexed audio data. The device 108 can play the foreground audio 116 via a speaker or the like, and store the background audio data for further processing and/or subsequent playback. In other examples, the device 108 can play the background audio 124 and store the foreground audio 116 for further processing and/or subsequent playback.

In further examples, sending the second processed audio at block 225 can include sending the foreground audio 116 via a primary channel, and sending the background audio 124 via an auxiliary channel. For example, the device 104 or the device 108 can be configured to establish a second call (e.g., via a callback mechanism from the device 108) and the device 104 can send the background audio 124 over the second call. In other examples, the call established at block 205 may support more than one media stream, and the device 104 can use a primary stream for the foreground audio 116, and an auxiliary stream for the background audio 124.

Following block 220 or 225, the device 104 can continue capturing audio data at block 210, and determining at block 215 whether to further alter background noise suppression behavior. The capture and segmenting of audio data at block 210 can be substantially continuous, and the determination at block 215 can be repeated at any of a variety of frequencies (e.g., once per second, although both more frequent and less frequent determinations at block 215 are contemplated).

As will be understood from the discussion above, through successive performances of blocks 210, 215, and 220 or 225, the device 104 can selectively suppress background noise, or retain background noise, in the audio data sent to the device 108 during the call. That is, for a certain portion of the call (e.g., a certain period of time) the device 104 can send the first processed audio data, while for another portion of the call, the device 104 can send the second processed audio data. The device 104 can also return to sending the first processed audio data during yet another portion of the call, e.g., in response to a further change in the determination at block 215.

The device 104 can also, in some examples, generate metadata at block 230, following either or both of blocks 220 and 225. The device 104 can be configured, for example, to execute one or more classifiers with the background audio 124 as input, to detect certain predetermined sounds in the background audio 124. The metadata can include, for example, timestamps indicating a position (in time) of a detected sound, and a tag indicating the nature of the detected sound. The metadata can be represented in one or more text files, signaling messages, or the like, sent to the device 108. The metadata can indicate the existence and/or timing of a wide variety of sounds. Examples of sounds indicated by metadata can include speech (e.g., originating from a source other than the operator 120), sounds indicating the presence of emergency service personnel (e.g., sirens), gunshots, animal sounds, environmental sounds such as running water and/or traffic-associated sounds (e.g., car horns, or the like), echoes or reverberation (e.g., indicating an attribute of the physical space surrounding the device 104), and the like. In other examples, block 230 can be omitted.

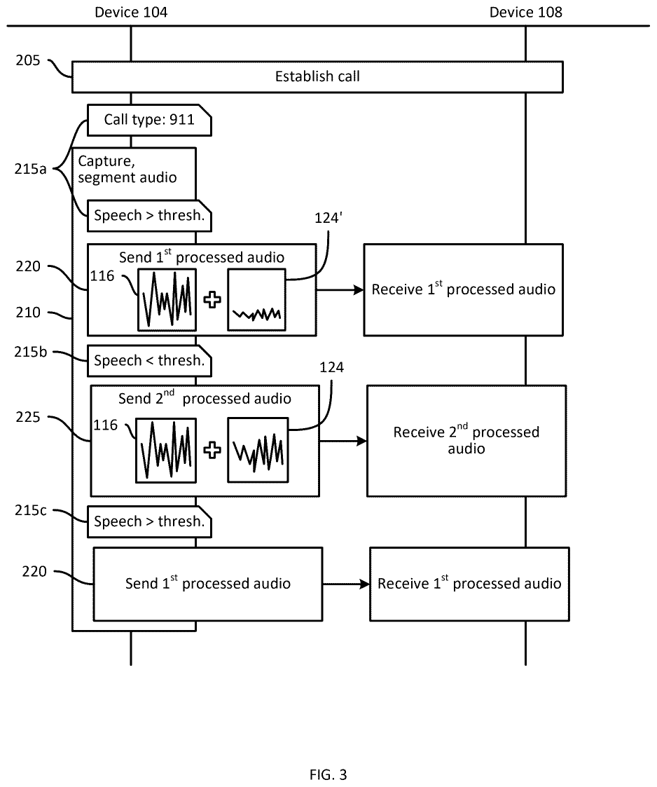

FIG. 3 illustrates an example performance of the method 200 in the system 100, with time represented vertically (though not necessarily to scale). As seen in FIG. 3, a call is established between the device 104 and the device 108 at block 205. At block 210, the device 104 captures audio via the microphone(s) 142, and segments the captured audio into foreground and background components. As illustrated in FIG. 3, the capture and segmentation of audio data is substantially continuous, although the handling of the segmented components may vary over time based on the determinations made at successive performances of block 215. At a first instance 215a of block 215, based on a call type (“911”) and an amplitude of speech from the operator 120 (e.g., an amplitude of the foreground component 116), the device 104 makes an affirmative determination at block 215. In this example, the criteria for disabling background noise suppression are that the call be an emergency call, and that the foreground component 116 have an amplitude below a threshold. Since only one of those criteria are satisfied, the device 104 suppresses background noise. Thus, at block 220, the device 104 sends first processed audio data including the foreground component 116 and an attenuated background component 124′. It will be understood that the first processed audio can include a waveform combining the components 116 and 124′, rather than separate components.

At a further instance 215b of block 215, the device 104 determines that an amplitude of operator speech has fallen below the predetermined threshold. The determination at block 215 is therefore negative, and at block 225 the device 104 is configured to send second processed audio data, including the foreground component 116 and the background component 124, e.g., without attenuation, or with amplification in some examples. In other examples, the foreground component 116 may be attenuated. It will be understood that although the same waveform icons are used in FIG. 3 to indicate foreground and background audio, the audio data captured and sent by the device 104 changes over time and does not necessarily exhibit the same waveform.

At a further instance 215c of the block 215, the device 104 determines that an amplitude of the foreground component 116 once again exceeds the threshold mentioned above, and the device 104 therefore sends first processed audio data, in which the background component 124 is suppressed (e.g., attenuated or discarded). The above process can continue until the call ends.

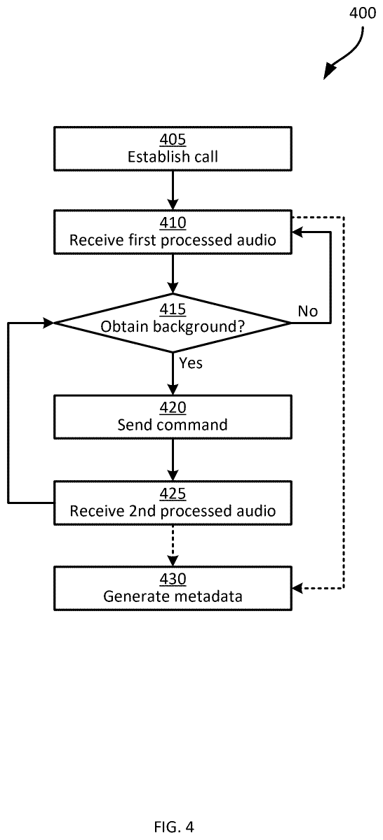

Turning to FIG. 4, a method 400 of selective background noise suppression control is illustrated. The method 400 is described below in conjunction with its performance by the device 108, e.g., via execution of the application 154 by the processor 150, and/or by equivalent dedicated hardware elements such as an ASIC, field-programmable gate array (FPGA) or the like implementing the functionality of the application 154. Performance of the method 400 configures the device 108 to affect the background noise suppression behavior exhibited by the device 104.

At block 405, the device 108 is configured to establish a call with the device 104. In some examples, e.g., in the case of an emergency call where the device 108 is a component of a PSAP, the call may be initiated by the device 104. In other examples, the device 108 can initiate the call, e.g., via transmission of a call request including an identifier of the device 104.

At block 410, the device 108 is configured to receive audio data from the device 104. In the example illustrated in FIG. 4, the device 108 receives first processed audio data, as the device 104 is configured, by default, to send first processed audio data (e.g., with background suppression enabled). In other examples, the device 104 can be configured not to suppress background noise by default, in which case the device 108 may begin by receiving the second processed audio data from the device 104.

At block 415, the device 108 is configured to determine whether to obtain background noise (e.g., the background component 124) from the device 104. The determination at block 410 can be made according to a variety of mechanisms. For example, at block 410 the device 108 can determine whether an amplitude of audio data received from the device 104 is below a threshold (which may indicate that the operator 120 is not speaking). In other examples, the device 108 can receive input, e.g., from the operator 132, instructing the device 108 to obtain background audio data from the device 104. The operator 132 can, for example, enter or otherwise provide a command to the device 108 via the input device 162 to obtain background noise from the device 104.

When the determination at block 415 is negative, the device 108 returns to block 410, and continues to receive first processed audio data from the device 104. In other words, following a negative determination at block 415, the device 108 may exert no control over background noise suppression behavior at the device 104, and the device 104 can therefore continue to operate according to its default configuration, which in this example is to suppress the background component 124.

When the determination at block 415 is affirmative, e.g., because the operator 132 provides input to the device 108, because the device 108 detects a reduction in amplitude of the audio data received from the device 104, or the like, the device 108 proceeds to block 420. At block 420, the device 108 is configured to send a command to the device 104. The command is configured to cause the device 104 to disable or otherwise modify suppression of the background component 124. In other words, the command sent at block 420 by the device 108 leads to a negative determination at block 215, at the device 104.

The command sent at block 420 can take various forms. In some examples, the command is an in-band command such as one or more tones (e.g., dual-tone multifrequency (DTMF) tones) that the device 104 is configured to recognize. The command can be input via a dial pad or the like at the device 108 in such examples. Other forms of in-band command include a parameter in one or more Real-time Transport Protocol (RTP) frames that indicates a background suppression mode to be used by the device 104 (e.g., enabled or disabled).

In other examples, the command sent at block 420 is an out-of-band command. For example, the command can include a control message such as a Real-time Transport Control Protocol (RTCP) message including a suppression mode parameter. In other examples, e.g., in the case of a cellular call where SIP and the Session Description Protocol (SDP) are used to establish and manage multimedia sessions, the command sent at block 420 can include an SDP Update message containing the above-mentioned suppression mode parameter.

In further examples, the command sent at block 420 can include initiation of a callback to the device 104. For example, the device 104 and the device 108 can be configured to establish simultaneous multimedia sessions, such that at block 420 the device 108 can initiate an auxiliary session, channel, or the like, with the device 104. The device 104 can be configured, in response to establishment of such an auxiliary channel, to send the background component 124 over the auxiliary channel. In other words, transmission of second processed audio data by the device 104 at block 225 can include sending the first processed audio data over the primary channel (e.g., the multimedia session established at blocks 205 and 405), and the background component 124 over the auxiliary channel.

At block 425, the device 108 is configured to receive the second processed audio data from the device 104, e.g., including the background component 124 with or without amplification, and optionally including the foreground component 116 (which may be attenuated in some examples).

At block 430, the device 108 can be configured to generate metadata as discussed above in conjunction with block 230. That is, either or both of the devices 104 and 108 can be configured to generate metadata based on the execution of one or more classifiers, e.g., using the background component 124 as input. The metadata generated at block 430 can be stored at the device 108 and/or presented to the operator 132 via the display 160. In other examples, the metadata generated at block 430 can be transmitted to a further computing device via the network 112.

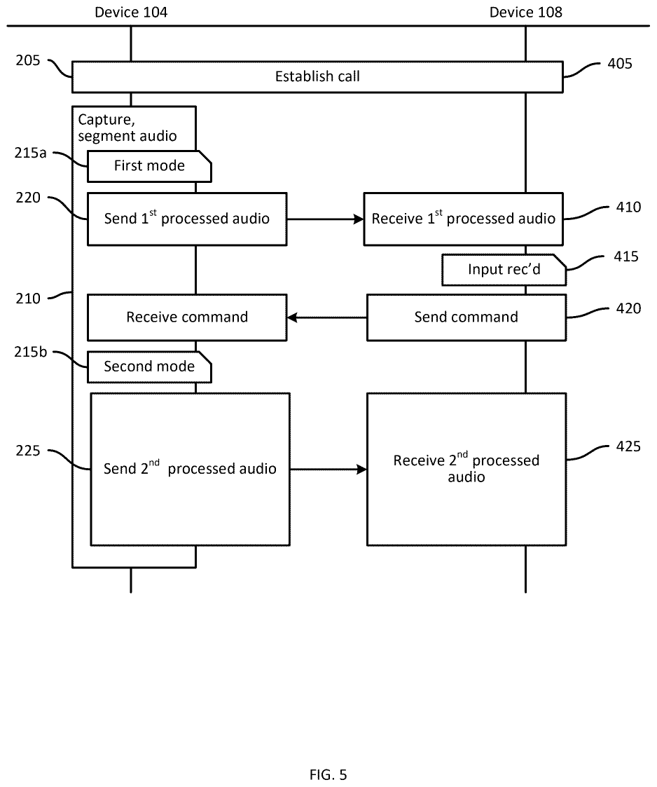

FIG. 5 illustrates an example performance of the method 400 at the device 108, alongside an example performance of the method 200 at the device 104. Following establishment of a call at blocks 205 and 405, the device 108 is configured to receive first processed audio at block 410. The first processed audio received at block 410 was generated and sent at the device 104, for example, via a first instance 215a of the determination at block 215, and a performance of block 220. In this example, the device 104 is configured to apply a default background suppression mode until instructed otherwise by the device 108.

At block 415 in this example, the device 108 receives input, e.g., via the input device 162 from the operator 132, such as a predefined keypad sequence or other suitable input. At block 420, the device 108 sends a command (e.g., DTMF tones or the like, as discussed above) to the device 104. The command causes the device 104, via a further instance 215b of the determination at block 215, to switch to a second background suppression mode. In the second mode, the device 104 can be configured to disable suppression of the background component 124, and generate and send second processed audio data that includes the background component (with or without the foreground component 116). At block 425, the device 108 then receives the second processed audio data from the device 104.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
establishing a communication session between a first communication device and a second communication device;
processing a command from the first communication device to control background noise suppression of the second communication device; and
controlling the background noise suppression based on the command.

2. The method of claim 1, further comprising controlling the background noise suppression at the second device based on the command.

3. The method of claim 2, wherein controlling the background noise suppression includes disabling suppression of background audio data captured at the second device, and transmitting the background audio data to the first device.

4. The method of claim 3, wherein transmitting the background audio data to the first device includes multiplexing the background audio data with foreground audio data.

5. The method of claim 3, wherein controlling the background noise suppression further includes amplifying the background audio data.

6. The method of claim 3, wherein the audio data includes speech of an operator of the second device, and wherein the background audio data includes sound distinct from the speech.

7. The method of claim 1, wherein the first communication device is a public safety communication device.

8. The method of claim 1, wherein the communication session is a public safety communication session.

9. The method of claim 1, wherein processing the command includes: at the first communication device, generating the command; and
wherein controlling the background noise suppression based on the command includes sending the command to the second communication device.

10. The method of claim 1, wherein processing the command includes: at the second communication device, receiving the command from the first communication device.

11. The method of claim 10, wherein the command includes an in-band tone.

12. The method of claim 10, wherein the command includes a Real-time Transport Protocol (RTP) message containing a suppression mode field.

13. A communication device, comprising:
a communication interface; and
a processor configured to:
establish a communication session with a second communication device;
receive a command from the second communication device to control background noise suppression; and
control the background noise suppression based on the command.

14. The communication device of claim 13, further comprising:
a microphone;
wherein the processor is configured to control the background noise suppression by disabling suppression of background audio data captured at the microphone, and transmitting the background audio data to the second communication device.

15. The communication device of claim 13, wherein the processor is further configured to transmit the background audio data to the second communication device by multiplexing the background audio data with foreground audio data.

16. The communication device of claim 13, wherein the processor is configured to control the background noise suppression by amplifying the background audio data.

17. The communication device of claim 13, wherein the second communication device is a public safety communication device.

18. The communication device of claim 13, wherein the communication session is a public safety communication session.

19. The communication device of claim 13, wherein the command includes an in-band tone.

20. The communication device of claim 13, wherein the command includes a Real-time Transport Protocol (RTP) message containing a suppression mode field.

21. A communication device, comprising:
a communication interface; and
a processor configured to:
establish a communication session with a second communication device;
generate a command to control background noise suppression at the second communication device; and
send the command to the second communication device.

22. The communication device of claim 21, wherein the command includes an in-band tone.

23. The communication device of claim 21, wherein the command includes a Real-time Transport Protocol (RTP) message containing a suppression mode field.
